(19) United States
(12) Patent Application Publication
(10) Pub. No.: US 2006/0190338 A1
(43) Pub. Date: Aug. 24, 2006

(54) Sales planning support system, sales planning support method, and computer product

(75) Inventors: Kaori Iida, Kanagawa (JP); Shoichi Yoshihiro, Tokyo (JP); Katsuaki Kikuchi, Chiba (JP); Kazuo Morishita, Kanagawa (JP); Kaori Kasahara, Tokyo (JP)

Correspondence Address: MORRISON & FOERSTER LLP, 1650 TYSONS BOULEVARD, SUITE 300, MCLEAN, VA, 22102, US

(73) Assignee: RICOH COMPANY, LTD.

(21) Appl. No.: 11/352,354

(22) Filed: Feb. 13, 2006

(30) Foreign Application Priority Data
Feb. 23, 2005 (JP) 2005-047928

(51) Int. Cl. G06Q 99/00; G06Q 20/00

(52) U.S. Cl. 705/16; 705/1

(57) ABSTRACT

A managing computer adds a bulk-sales negotiation ID to a bulk-sales negotiation to distinguish the bulk sales negotiation from a normal sales negotiation. An amount of scheduled shipment and completed shipment for the bulk sales negotiation is managed by a bulk-sales-negotiation managing unit based on the bulk-sales negotiation ID. The managing computer obtains an amount of completed shipment of a regular negotiation by subtracting an amount of completed shipment of the bulk-sales negotiation from a total amount of completed shipment. The managing computer calculates a seasonal index based on an amount of completed shipment according to a stratification of products to design a sales plan. The managing computer adds an amount of schedule shipments of the bulk sales negotiation to the sales plan.

### CROSS-REFERENCE TO RELATED APPLICATIONS

The present document incorporates by reference the entire contents of Japanese priority document, 2005-047928 filed in Japan on Feb. 23, 2005.

### BACKGROUND OF THE INVENTION

1. Field of the Invention

The present invention relates to a technology for supporting creation of a sales plan for products by managing information on sales negotiation of the products.

2. Description of the Related Art

To reduce stocks while avoiding out-of-stock condition, chain management (SCM) has been attracting attention. In the SCM, it is important to accurately grasp a demand for products. If a trend in the demand can be accurately grasped, it is possible to introduce appropriate amount of products into the market. By reflecting the demand grasped to a series of processes such as manufacturing and sales, it is possible to enhance sales figures.

Therefore, in business enterprises, a sales force automation (SFA) system has been introduced as a system for supporting sales operations. A technique is also disclosed for reflecting circumstances of sales operations to commodity supply plans so that a commodity supply plan that meets the demand variable in a short term can be easily determined (for example, Japanese Patent Application Laid-Open No. 2002-207859). In this technique, based on information input by a sales staff, an SFA server stores transaction information including a scheduled amount of commodities to be sold in a customer database in each commercial transaction performed to supply commodities to customers. In accordance with a progress in sales operations, progress information that indicates a degree of the progress of the commercial transaction is stored in the customer database in association with the transaction matter information. Based on the transaction matter information and the progress information, the SCM server estimates an amount of commodities to be demanded in the future.

Another technique is disclosed for sharing sales negotiation information input by a salesperson with, for example, a production division. Based on the sales negotiation information, a sales estimation quantity (sales potential) is determined to arrange a production schedule according to the determined sales estimation quantity (for example, Japanese Patent Application Laid-Open No. 2003-281414). In this technique, a server device is connected to a terminal device on a salesperson side and to a terminal device on production side via a network, and can access a sales negotiation information database (DB). The server device accepts the input of sales negotiation information including commodity composition information from the terminal devices for each sales-negotiation matter, and registers the sales negotiation information in the sales negotiation information DB. The server device stores a history of orders indicating whether the sales-negotiation matter registered has been actually ordered, and calculates, based on the history, an order decision rate during a predetermined period. Commodities to be counted as the sales estimation quantity are determined according to calculated order decision rate, and sales negotiation information including the determined sales estimation quantity are classified for each commodity, to be provided to the terminal devices.

Moreover, a technique is disclosed for managing an inventory reference value day by day and maintaining a proper inventory quantity (for example, Japanese Patent Application Laid-Open No. 2004-75321). In this technique, an inventory prediction quantity is calculated based on a sales planning volume, a warehousing volume, and an inventory-result-predicted volume on a specific day. Furthermore, a fixed-period latitude inventory, a physical distribution inventory, and a physical distribution latitude inventory are calculated, and an ordinary inventory reference value is calculated based on the fixed-period latitude inventory, the physical distribution inventory, the physical distribution latitude inventory, and a safe inventory volume. Further, a lump inventory reference value is calculated, and an inventory reference value is calculated based on the ordinary inventory reference value and the lump inventory reference value. A replenishment quantity is then calculated based on a difference between the inventory reference value and the inventory prediction quantity.

However, the sales operations include a bulk sales negotiation having special circumstances as well as a steady sales negotiation. If the bulk sales negotiation and the steady, normal sales negotiation are managed together, the estimation of sales will be influenced by the estimation of bulk sales, so that an accurate sales forecast becomes difficult. Additionally, since a demand varies depending on a season, it is important to exactly incorporate this seasonal variation into the sales estimation.

Furthermore, since a change of demand depends on a product, it is necessary to make a sales plan and a production schedule dynamically corresponding to the product.

### SUMMARY OF THE INVENTION

It is an object of the present invention to at least solve the problems in the conventional technology.

A system according to one aspect of the present invention is for supporting creation of a sales plan for products that includes a core part and an optional part. The system includes a receiving unit configured to receive data on sales negotiations for the products; a detecting unit configured to detect a specific negotiation, based on a predetermined condition, from among the sales negotiations; a specific-negotiation storing unit configured to apply an identifier to data of the specific negotiation, and to store the data of the specific negotiation, the data including an amount of scheduled shipments of the products and an amount of completed shipments; a completed-shipment storing unit configured to store data on an amount of completed shipments of each negotiation; a regular-shipment calculating unit configured to calculate an amount of completed shipments of regular negotiation that does not correspond to the specific negotiation by subtracting the amount of completed shipments of the specific negotiation from the amount of completed shipments in the completed-shipment storing unit; and a sales-plan creating unit configured to create a sales plan for the products based on the amount of completed shipments of the regular negotiation and the amount of scheduled shipments of the specific negotiation.

A method according to another aspect of the present invention is of supporting creation of a sales plan for products that includes a core part and an optional part. The method includes receiving data on sales negotiations for the products; detecting a specific negotiation, based on a predetermined condition, from among the sales negotiations; adding an identifier to data of the specific negotiation; storing the data of the specific negotiation, the data including an amount of scheduled shipments of the products and an amount of completed shipments; storing data on an amount of completed shipments of each negotiation; calculating an amount of completed shipments of a regular negotiation that does not correspond to the specific negotiation by subtracting the amount of completed shipments of the specific negotiation from the amount of completed shipments of each negotiation; and creating a sales plan for the products based on the amount of completed shipments of the regular negotiation and the amount of scheduled shipments of the specific negotiation.

A computer-readable recording medium according to still another aspect of the present invention stores a computer program for realizing the method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a system according to an embodiment of the present invention;

FIG. 2 is a flowchart of a process according to the embodiment;

FIG. 3 is a schematic for illustrating a process according to the embodiment;

FIG. 4 is a schematic of a process according to the embodiment;

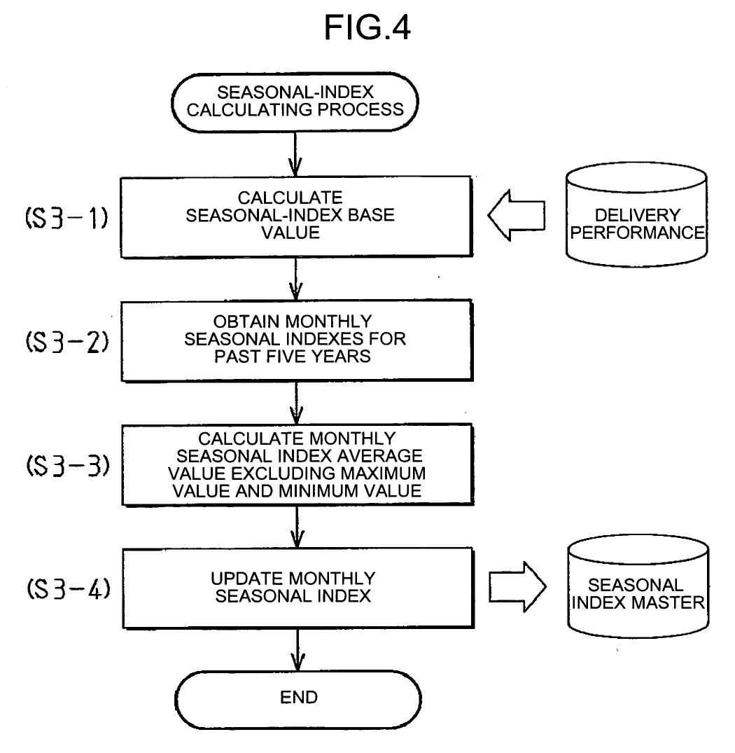

FIG. 5 is a schematic of a process according to the embodiment;

FIG. 6 is a schematic of a process according to the embodiment;

FIG. 7 is a schematic of a daily separating process according to the embodiment;

FIG. 8 is a schematic of a daily separating process according to the embodiment; and

FIG. 9 is a schematic of a bulk-sales negotiation Identification (ID) in a delivery performance.

### DETAILED DESCRIPTION OF THE PREFERRED EMBODIMENTS

Exemplary embodiments according to the present invention will be explained below with reference to accompanying drawings. In this embodiment, a sales planning support system, a sales planning support method, and a sales planning support program for arranging a sales plan based on a past delivery performance are explained. In this embodiment, a sales plan is designed with a distinction between a normal-sales negotiation matter and a bulk-sales negotiation matter that is a specific sales-negotiation matter.

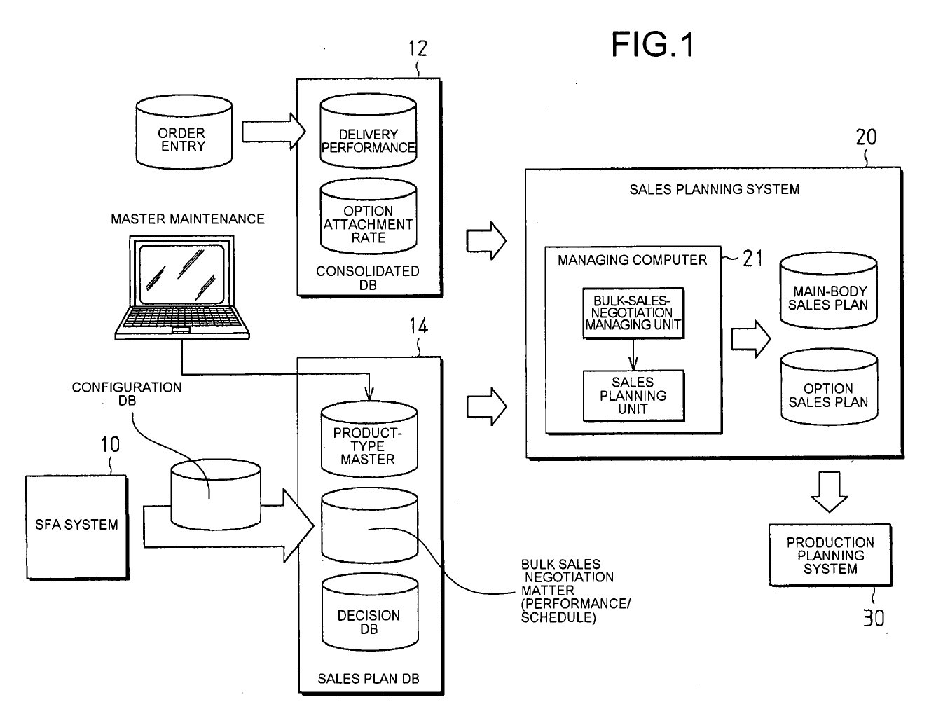

As shown in FIG. 1, an SFA system 10, a consolidated DB 12, a sales plan DB 14, and a sales planning system 20 as a sales planning support system are used. These are connected together via a network, and send and receive data to and from each other.

The SFA system 10 is a sales force automation system used for sales and marketing support. In this SFA system 10, besides customer information, information on a contact history, a negotiation process, and a sales schedule are stored in the database to share information on the progress of and expectations of success in a sales negotiation among salespersons.

The consolidated DB 12 stores delivery performance data and option attachment rate data.

In the sales planning system 20, the delivery performance data includes data concerning the delivery history of a target product from which a sales plan is designed. This delivery performance data is registered by use of data on order entry. Specifically, a delivery quantity (sales performance value) in which delivery results during the past five years or more are subdivided according to a type identifier or a date of sales of a product is recorded. In this embodiment, a model number by which the model of a product is specified is used as the product type.

The option attachment rate data includes data on a rate of attaching each option to a product corresponding to each of the product-type identifiers.

The sales plan DB 14 stores specific sales-negotiation data. Bulk-sales negotiation data is stored in the sales plan DB 14. Product type master data and a decision DB are additionally kept in the sales plan DB 14.

Data of customer information, a sales-negotiation name, a target model, a quantity (planned sales amount, actual performance), and a delivery date is recorded in the bulk-sales negotiation data, in order to carry out schedule/performance management concerning a sales negotiation provided with a bulk-sales negotiation ID.

Data of commodity groups, layers, series, and product types is recorded in the product type master data. In the product type master data, a series identifier and a layer identifier are associated with the product-type identifier. Herein, the “commodity group” denotes the product types of commodities, such as “PPC (plain paper copier)”, “LP (laser printer)”, “scanner”, and “facsimile”. The “layer” denotes features of the product type. For example, in the PPC, the features are “color PPC”, “wide use”, “large quantity”, and “great width”. In the LP, the features are “A3 monochrome” and “A4 color”. The “series” is a title representing a chain of a series of commodity groups. In other words, the “layer” realizes a common function within the range exceeding the “series”. Release information about a sales promotional campaign or a new series is stored in the decision DB.

The sales planning system 20 is a computer server used when a sales plan is designed. The sales planning system 20 includes a managing computer 21 including a control unit (central processing unit), a storing unit (random-access memory, read-only memory, etc.), and a communication unit. The sales planning system 20 including the managing computer 21 performs a process explained later (i.e., a process including a normal value calculating stage and a sales planning stage), and functions as a bulk-sales-negotiation managing unit and a sales planning unit.

Further, the bulk-sales-negotiation managing unit manages data about the bulk sales negotiation, and performs the progress management, decision processing, and partial-delivery plan management of the bulk sales negotiation.

On the other hand, the sales planning unit arranges a sales plan with a distinction between the normal sales negotiation and the bulk sales negotiation. The sales planning unit supports the arrangement of the monthly sales plan of a main body-and the monthly sales plan of an option. In a specific product, the sales planning unit supports the arrangement of a weekly sales plan, thereby functions as a normal value calculating unit, a sales planning unit, an option-sales planning unit, a subdivision plan calculating unit, a landing-prospect calculating unit, and a sales-plan correcting unit.

The sales planning system 20 calculates main-body sales plan data and option sales plan data. A corrected sales plan is provided to a production planning system 30. In the production planning system 30, production management is carried out based on this sales plan.

When sales negotiations are conducted, a sales representative (salesperson) inputs sales-negotiation information using the SFA system 10. Information about a customer with whom sales negotiations are being conducted, a sales-negotiation name, a target model, a quantity, a delivery date, etc., is input to the sales-negotiation information. Data about a setting condition accepted when the sales negotiations are conducted or customization at each sales-negotiation process is registered in a configuration DB as a piece of setup information. For example, information about the special setting of a product to be delivered, a kitting method, or shipping/delivery instructions is registered.

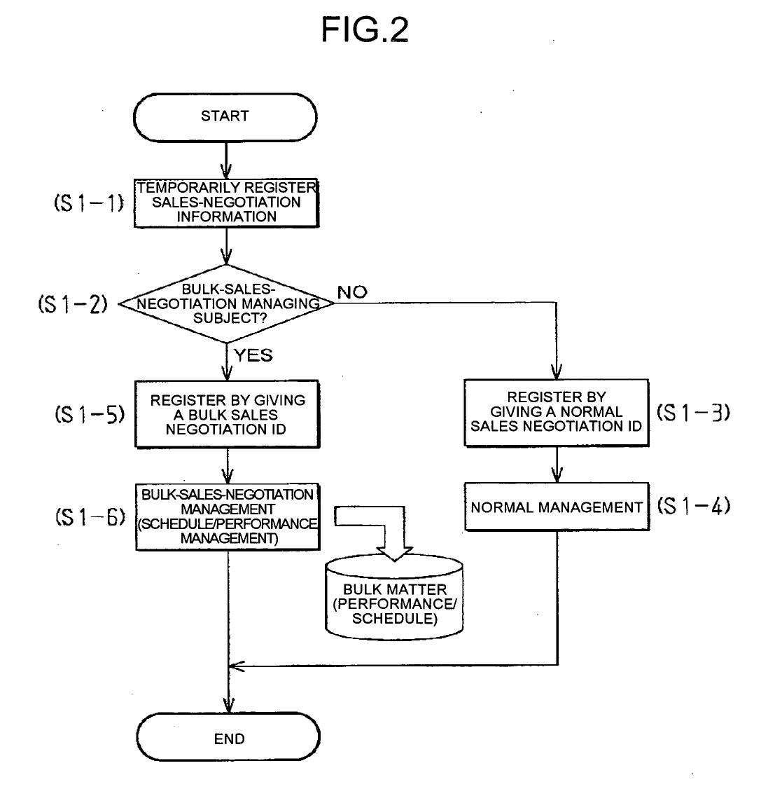

When the sales-negotiation information is input, the managing computer 21 of the sales planning system 20 performs sales management by the bulk-sales-negotiation managing unit. Although an example in which the managing computer 21 of the sales planning system 20 performs the sales-negotiation managing process shown in FIG. 2 is explained in this embodiment, a function by which a sales-negotiation ID is given to another system (for example, the SFA system 10) may be provided.

First, the managing computer 21 temporarily registers sales-negotiation information (step S1-1). The managing computer 21 then determines whether this is a bulk-sales-negotiation managing subject (step S1-2). In this embodiment, the suitability of the bulk-sales-negotiation managing subject is determined in accordance with a basic number that has the possibility of influencing a production schedule. For example, when the number of target products in one sales-negotiation act is 30 or more, this is determined as the bulk-sales-negotiation managing subject, which is a predetermined standard treated as a specific sales-negotiation matter.

If the sales-negotiation information does not correspond to a bulk-sales-negotiation managing subject (“NO” at step S1-2), the managing computer 21 gives a normal sales negotiation ID (step S1-3). This piece of sales negotiation is regarded as a normal sales negotiation, and undergoes a managing process (step S1-4).

On the other hand, if the sales-negotiation information corresponds to a bulk-sales-negotiation managing subject (“YES” at step S1-2), the managing computer 21 gives a bulk-sales negotiation ID that indicates that the sales negotiation is a bulk-sales-negotiation managing subject (step S1-5). This bulk-sales negotiation ID functions as a specific identifier that is given to a specific sales-negotiation matter.

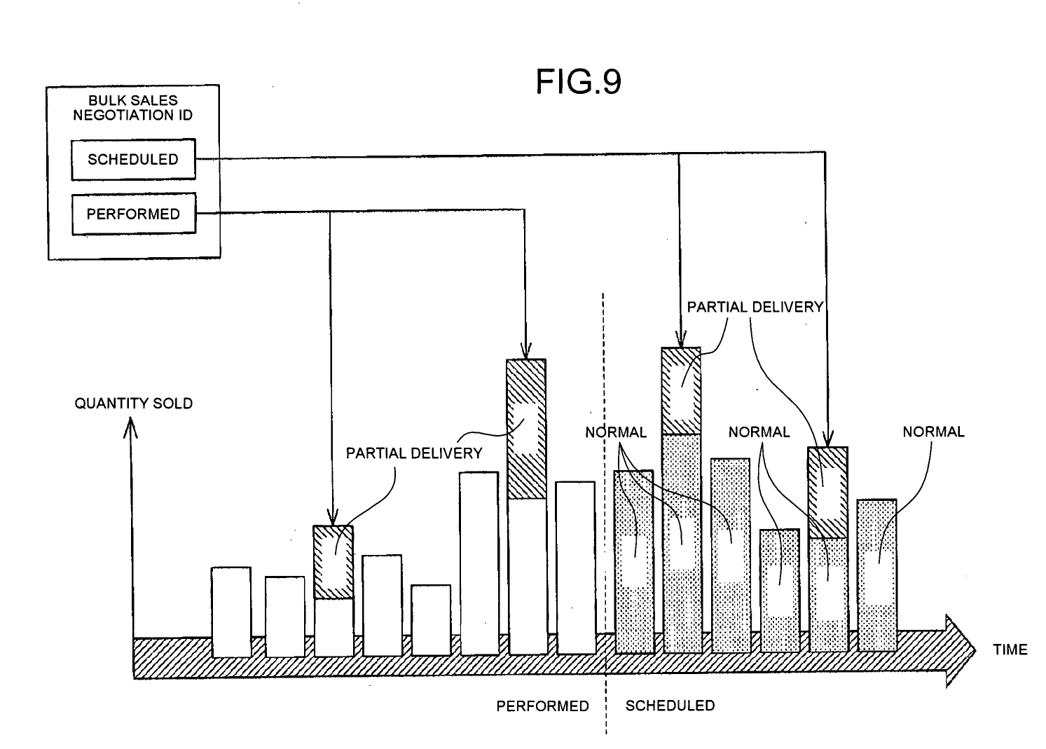

The managing computer 21 then executes the managing process as a bulk-sales-negotiation matter (step S1-6). Specifically, data input by a sales representative and the bulk-sales negotiation ID are associated with each other, and are registered as bulk-sales-negotiation matter management data. Thereafter, schedule/performance management is performed by the bulk-sales-negotiation managing unit by use of the given bulk-sales negotiation ID. Herein, sales negotiation progress management and delivery schedule management are performed. This delivery schedule includes a partial delivery plan according to which the delivery date is subdivided to deliver products for a quantity order. As a result, as shown in FIG. 9, schedule management and performance management are performed in the sales performance by use of the bulk-sales negotiation ID.

Based on a delivery performance, sales planning management is performed by the sales planning unit of the managing computer 21. First, the managing computer 21 executes the counting operation of a delivery performance for normal sales negotiations (step S2-1). As shown in FIG. 9, in the delivery performance (delivery results), normal sales negotiation matters and bulk-sales-negotiation matters exist together. Further, the bulk-sales-negotiation matters mingle in the delivery results by subdividing the delivery date or by delivering ordered products to different locations. As explained above, a bulk-sales negotiation ID is given to a bulk-sales-negotiation matter, and is associated with the delivery performance. Therefore, the number of delivery products to each of which the bulk-sales negotiation ID has been given is subtracted from the delivery performance. As a result, a normal delivery performance by product type (normal sales performance value) is calculated.

The managing computer 21 then executes a counting operation by series and a counting operation by layer (step S2-2). Specifically, the number of series identifiers associated with the product-type identifier and the number of layer identifiers associated with the product-type identifier are calculated. As a result, the total value by series and the total value by layer are obtained.

Next, the managing computer 21 calculates a series/product type structural ratio (step S2-3). Herein, a structural ratio by product type within a past performance use range is formed based on past (five-year) delivery-performance-by-product-type data. First, a performance (average value) by product type is calculated. That is, a delivery performance (average value) by product type is calculated within the past delivery performance use range defined by a product type master. The structural ratio of the product type to the layer is then calculated. In this case, the structural ratio of the product type is calculated by dividing a delivery-performance-by-product type average value by the total of delivery-performance-by-product-type average values corresponding to the layer. As a result, structural-ratio file data is obtained.

Further, the managing computer 21 updates a seasonal index by use of the delivery-performance-by-layer data (step S2-4). In this embodiment, the fluctuations of the product types can be absorbed by calculating the seasonal index according to each layer.

The managing computer 21 calculates a seasonal-index base value (step S3-1). Herein, for the delivery performance by product type of a date, which is the last updated date, the year-month minimum value of a product type belonging to a corresponding layer is extracted and output according to each layer by use of the product type master. Based on a moving average value, the total of the performance values until the month concerned from eleven months ago is calculated, and the moving average value of the month concerned is obtained by dividing the total by 12. The seasonal-index base value of the month concerned is then obtained by dividing the delivery performance of the month concerned by the moving average value. This seasonal-index base value is the ratio of the month concerned in the performances for the past twelve months.

Next, the managing computer 21 then obtains monthly seasonal indexes for the past five years (step S3-2). Herein, yearly/monthly seasonal-index base values for the past five years are obtained from a data storing unit. The managing computer 21 then calculates a monthly seasonal index average value excluding the maximum value and the minimum value (step S3-3). The obtained yearly/monthly seasonal-index base values for the past five years are sorted by month, and monthly seasonal indexes for the three years, in which the maximum value and the minimum value are excluded in the monthly seasonal index of each month, are specified. A monthly seasonal index average value is obtained by the month-by-month calculation of the average value of the monthly seasonal indexes for the three years. If the seasonal-index base values for the past five years cannot be obtained, the average value is calculated as follows. If the seasonal-index base values are those for one year or less, reference is made to a base value according to another layer, for example, according to a use layer defined by the layer master. If the seasonal-index base values are those for five years or less, the average value is calculated as a simple arithmetic average.

Thereafter, the managing computer 21 updates the monthly seasonal index (step S3-4). First, the monthly seasonal index average values obtained above are totaled up so as to obtain a coefficient in which this total value is 1200. The monthly seasonal index average value of the month concerned is then multiplied by this coefficient so as to obtain a final seasonal index. With the obtained seasonal index as seasonal-index master data, the record is updated.

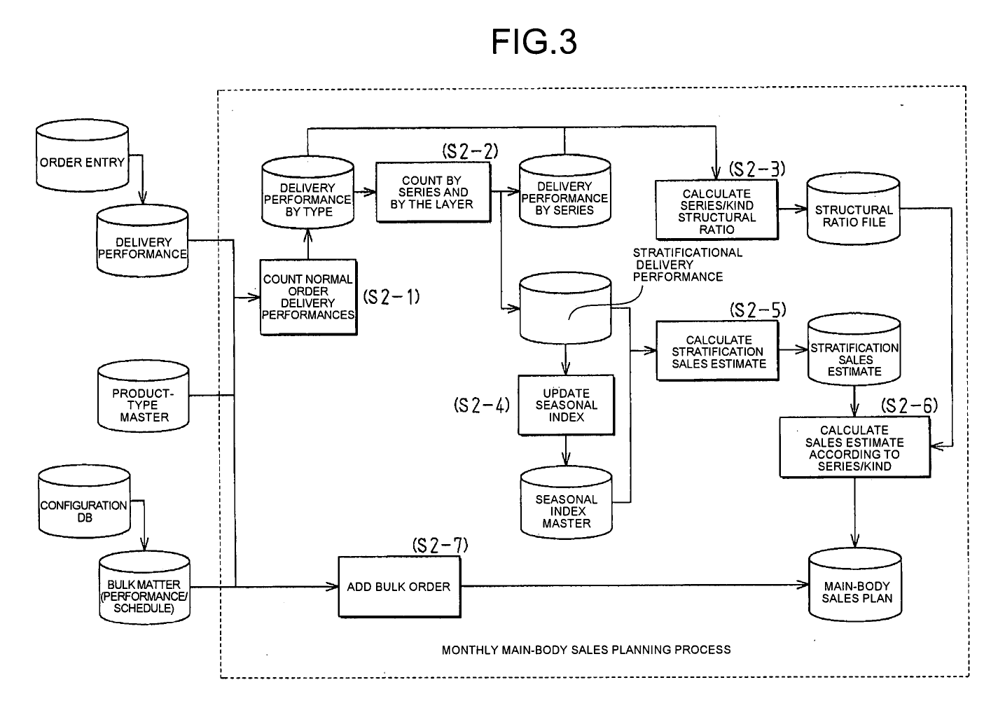

As shown in FIG. 3, the managing computer 21 calculates a sales estimate according to each layer (step S2-5). Herein, the seasonal index obtained through the seasonal-index calculating process and the stratificational delivery performance obtained at step S2-2 are used. Specifically, first, the delivery performances for the last three months are obtained, and an average value (average monthly sales value) thereof is calculated. Likewise, the seasonal indexes for the last three months are obtained, and an average value (average seasonal index) thereof is calculated. The average monthly sales value is divided by the average seasonal index, and is multiplied by the seasonal index of the month concerned. As a result, a sales estimate is obtained.

The managing computer 21 then calculates a sales estimate according to the series and the product type (step S2-6). The calculation is performed by applying the series/product type structural ratio obtained at step S2-3 to the stratification sales estimate obtained at step S2-5. As a result, a sales plan (normal sales plan) of the main body with respect to a normal quantity is obtained.

Next, the managing computer 21 performs an adding operation for an order received in bulk (step S2-7). Specifically, the managing computer 21 specifies a scheduled quantity to be delivered in the month concerned by use of bulk-sales negotiation data, and adds the number of products ordered in bulk to the normal sales plan of the main body. Thus, the main-body sales plan is completed.

The managing computer 21 calculates the average of the by-product type attachment rate and the gross attachment rate for the last three months, and calculates a subject/off-the-subject ratio (step S4-1). Herein, a calculation is performed with distinction between a case where the quantity is managed for each product type like direct selling (hereinafter, “subject”) and a case where the quantity is inclusively managed by the gross like agency selling (hereinafter, referred to as “off-the-subject”). When a plan for the N-th month of the year is designed, the following formulas are used to calculate a by-product type attachment rate average, a gross attachment rate average in, for example, agency selling, a subject ratio average, and an off-the-subject ratio average.

By-product type attachment rate average=[(N−1)th month by-product type option subject number+(N−2)th month option subject number+(N−3)th month option subject number]/[(N−1)th month main-body subject number+(N−2)th month main-body subject number+(N−3)th month main-body subject number)]

Gross attachment rate average=[(N−1)th month by-product type option subject number total+(N−2)th month option subject number total+(N−3)th month option subject number total]/[(N−1)th month by-product type main-body subject number total+(N−2)th month main-body subject number total+(N−3)th month main-body subject number total]

Subject ratio average=[(N−1)th month subject number+(N−2)th month subject number+(N−3)th month subject number]/[(N−1)th month (subject number+off-the-subject number)+(N−2)th month (subject number+off-the-subject number)+(N−3)th month (subject number+off-the-subject number)]

Off-the-subject ratio average=[(N−1)th month off-the-subject number+(N−2)th month off-the-subject number+(N−3)th month off-the-subject number)]/[(N−1)th month (subject number+off-the-subject number)+(N−2)th month (subject number+off-the-subject number)+(N−3)th month (subject number+off-the-subject number)]

In an option-main-body product type base, the following formulas are used to calculate the by-product type attachment rate, the subject ratio, and the off-the-subject ratio.

By-product type attachment rate=option subject number÷main-body subject number

Subject ratio=main-body subject number/(main-body subject number+main-body off-the-subject number)

Off-the-subject ratio=l-subject ratio

In an option product type base, the gross attachment rate is as follows.

Gross attachment rate=option off-the-subject number total/main-body off-the-subject number total

Thereafter, the managing computer 21 divides the sales plan (step S4-2). Herein, the subject is calculated as follows.

Main-body subject planning number=(planed month) main-body sales planning number×subject ratio

Subject option planning number=main-body subject planning number×by-product type attachment rate

On the other hand, the off-the-subject is calculated as follows.

Main-body off-the-subject planning number=(planed month) main-body sales planning number×off-the-subject ratio

Off-the-subject option planning number=main-body off-the-subject planning number×agency-selling gross attachment rate

The managing computer 21 then calculates an option sales estimate (step S4-3). Herein, an option sales plan (option normal sales plan) with respect to a normal quantity is calculated by adding the subject option planning number and the off-the-subject option planning number together.

Thereafter, the managing computer 21 performs an adding operation for the bulk (step S4-4). Specifically, the managing computer 21 specifies a scheduled quantity to be delivered in the month concerned by use of bulk-sales negotiation data, and adds an option number about which sales negotiations are performed for an order received in bulk to the normal option sales plan. Thus, the option sales plan for each option is completed.

The main-body sales plan and the option sales plan obtained as above are corrected by use of the decision DB. Release information about a sales promotion campaign and about a new series is stored in the decision DB. The sales plan is corrected by use of this information.

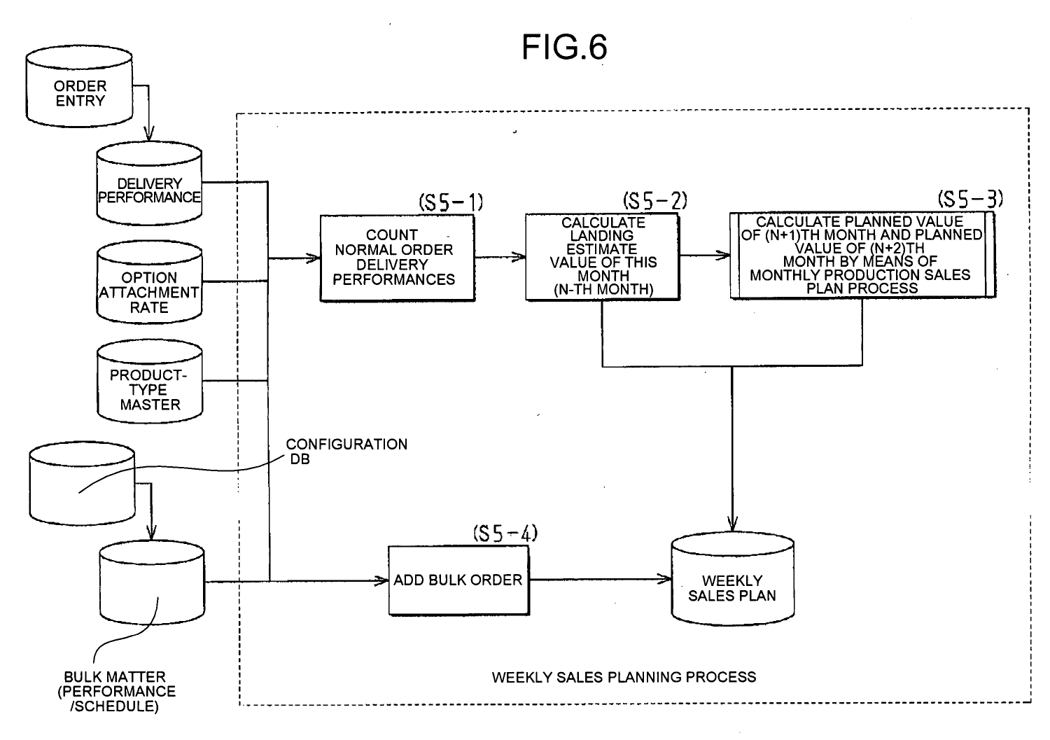

Next, a weekly main-body sales planning process will be explained with reference to FIG. 6. In this embodiment, a weekly sales plan is formulated about a predetermined product. Specifically, the planned value of the month concerned of a monthly sales plan is reviewed from the accomplishment rate (performance/plan) in the previous four weeks.

First, the managing computer 21 counts the normal delivery performances (step S5-1). The managing computer 21 then calculates the landing prospect value of this month (the N-th month) (step S5-2). The landing prospect value of this month mentioned here is obtained by multiplying the last reviewed result by the rate of divergence for the last four weeks. The rate of divergence for the last four weeks denotes the degree of divergence between the plan for the last four weeks and the performance (subdivided sales performance value) for the last four weeks. The plan for four weeks is obtained by subdividing the last reviewed result into daily pieces and counting the subdivided sales plans (in this embodiment, daily sales planning numbers) for this period.

A process for calculating a daily sales ratio (subdivided sales ratio), which is that of a daily sales schedule, will now be explained. As explained above, the monthly sales plan is formulated by adding a normal order (i.e., order received normally) and a bulk order (i.e., order received in bulk) together. Herein, the bulk order is supposed to be associated with a predetermined scheduled day for delivery. On the other hand, the normal order (subdivided normal sales plan) is obtained by multiplying a monthly normal order by a daily sales ratio. This daily sales ratio is calculated based on the past daily delivery performance.

Based on twenty workdays (20 WDs), the past delivery performance is converted into twenty workdays, and the ratio of a twenty-day standard, which is a subdivided sales standard, is determined. Herein, the average of the same month in the past three years of the same series is used.

First, if the number of the past delivery performance workdays is 20, this number is used without being changed.

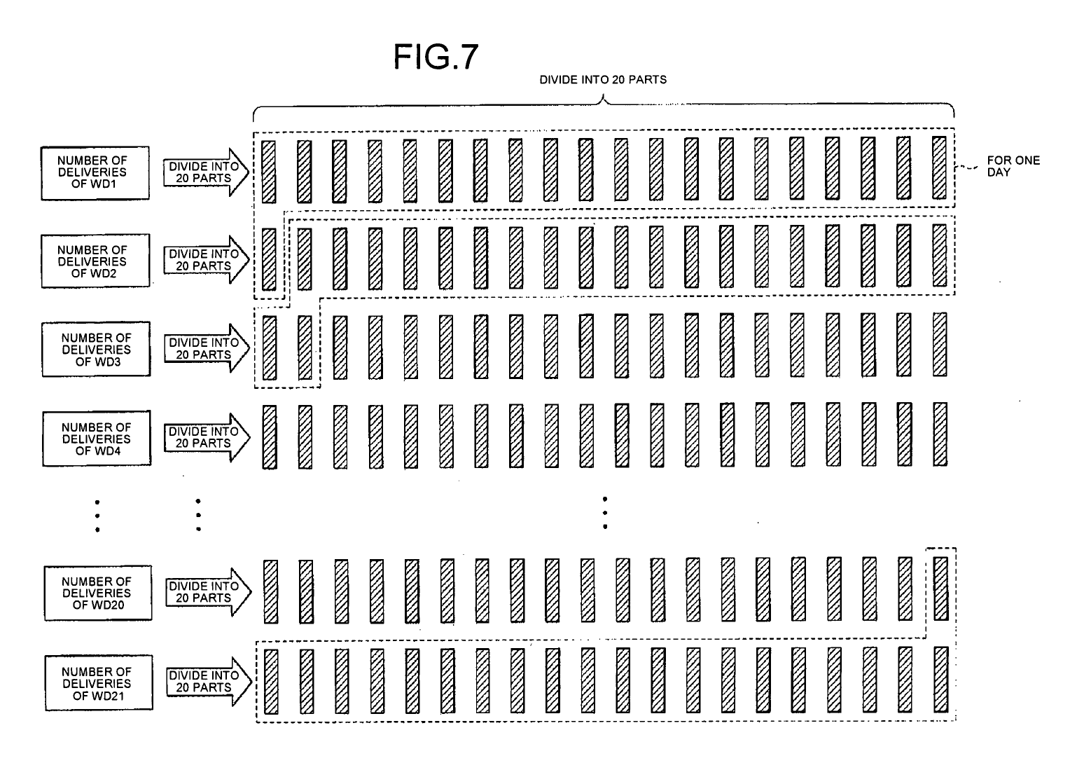

On the other hand, if the number of the workdays is M, the daily delivery performance is divided into twenty parts, and the twenty parts are collected into units each of which consists of M parts, from the first, for one day. If the number of the workdays (WDs) is 21 as shown in FIG. 7, the daily performance is divided into twenty parts, and 21 parts are united together for one day. As a result, the 20-day standard is formed.

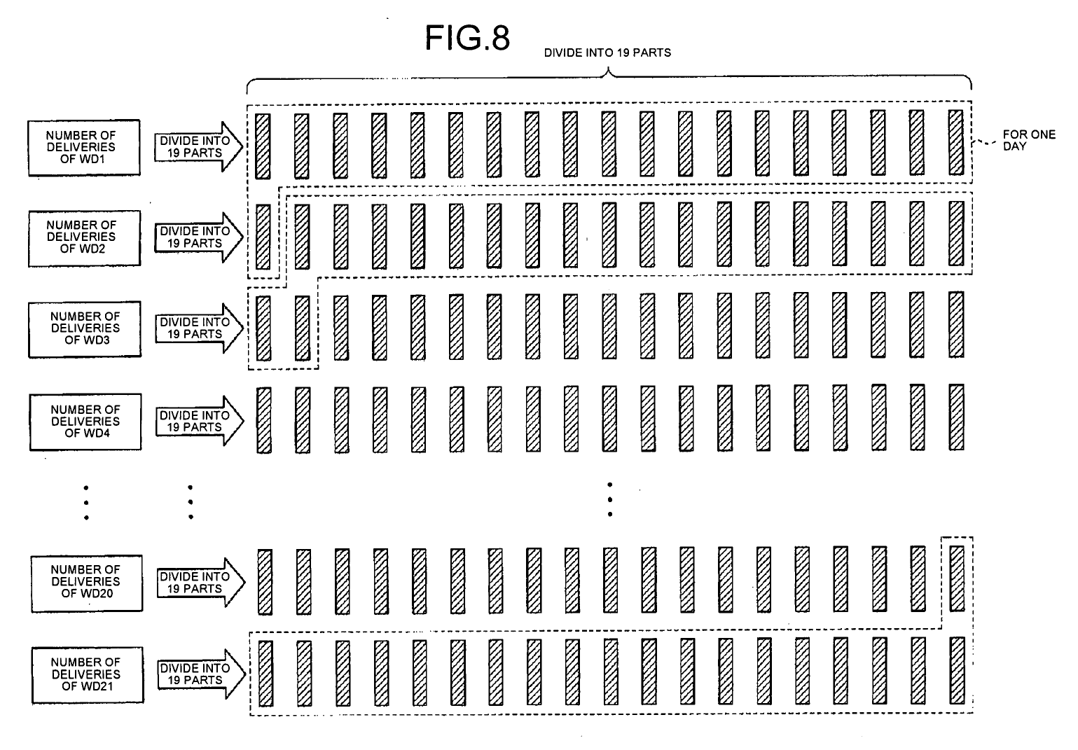

Thereafter, this 20-day standard is converted into actual workdays. If the number of the actual workdays is 20, the 20-day standard is used without being changed. If the number of the actual workdays is N, the 20-day standard is divided into N parts, and twenty parts are united together, from the first, for one day. If the number of the actual workdays is 19 as shown in FIG. 8, the 20-day standard is divided into 19 parts, and 20 parts are united together for one day. Thus, the performance is divided into daily pieces, so that the daily sales ratio is obtained.

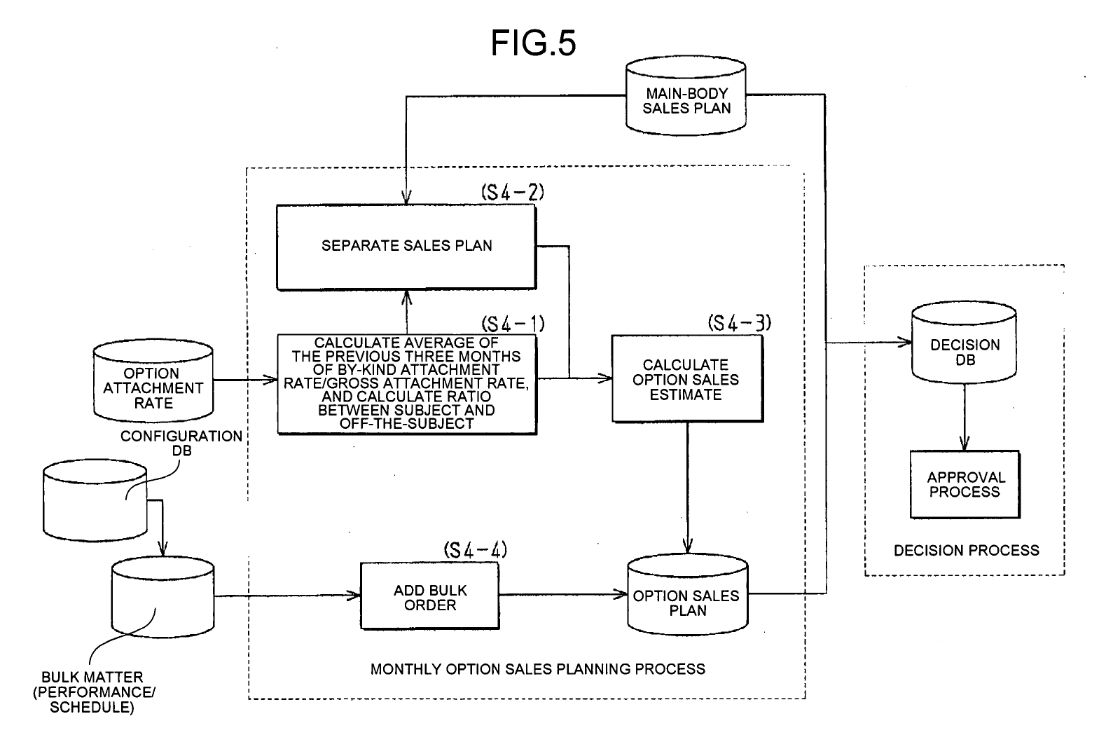

Thereafter, the managing computer 21 calculates a planned value of the (N+1)th month and a planned value of the (N+2)th month by means of the monthly sales planning process shown in FIG. 6 (step S5-3). Herein, for the landing prospect value of the N-th month, the planned value of the (N+1)th month and the planned value of the (N+2)th month are re-calculated by means of the monthly plan calculating process shown in FIG. 5.

Thereafter, the managing computer 21 performs an addition operation for the bulk order (step S5-4). Specifically, the managing computer 21 specifies a scheduled quantity to be delivered by use of bulk-sales negotiation data in the week concerned, and adds the number of main bodies ordered in bulk to the number of main bodies sold normally. Thus, the weekly sales plan is completed.

According to this embodiment, the following effects can be achieved.

In the embodiment, the managing computer 21 determines whether the subject is a bulk-sales-negotiation managing subject (step S1-2). If the subject corresponds to the bulk-sales-negotiation managing subject (“YES” at step S1-2), the managing computer 21 gives a bulk-sales negotiation ID (step S1-5). The managing computer 21 then executes the managing process as a bulk-sales-negotiation matter (step S1-6). Specifically, data input by a sales representative and the bulk-sales negotiation ID are associated with each other, and are registered as bulk-sales-negotiation matter management data, and, after that, the schedule/performance are managed by use of the given bulk-sales negotiation ID. Therefore, in the delivery performance, the bulk order and the normal order can be dispersed. Although the delivery performance includes the bulk order and the normal order, the order of a bulk sales negotiation is specific and concrete whereas the normal order is inclusive. These are also different in behavior from each other. Therefore, the sale of normally ordered products can be exactly estimated by separating these from each other without being influenced by the delivery performance by the bulk sales negotiation.

In the embodiment, the suitability of the bulk-sales-negotiation managing subject is determined in accordance with a basic number that has the possibility of influencing a production schedule. If the sales-negotiation information corresponds to the bulk-sales-negotiation managing subject, the managing computer 21 gives a bulk-sales negotiation ID (step S1-5). Although the bulk order mingles with the normal order, for example, as a result of being incorrectly input by manual operation, the management can be exactly performed by clarifying the standard for the bulk-sales negotiation ID.

In the embodiment, the managing computer 21 totals up the delivery performances of the normal order (step S2-1). The managing computer 21 then executes counting operations by series and by layer (step S2-2). When a product is purchased, a purchaser has an objective for purchasing the product, and hence, if the product meets the objective, the purchaser might purchase a product having a similar function in other series. Therefore, the purchasing trend of customers can be more exactly grasped, and the trend of sales can be forecasted by classifying the delivery performances while using the concept of the “layer.”

In the embodiment, the managing computer 21 updates a seasonal index by use of delivery-performance-by-layer data (step S2-4). Since the purchasing trend varies according to the season, a plan tempered with seasonal variations from the past results can be formulated.

In the embodiment, the managing computer 21 calculates the landing prospect value of the month (the N-th month) (step S5-2). Herein, a daily sales ratio is calculated based on the past daily delivery performance. Thus, the daily sales ratio is obtained. The managing computer 21 then calculates a planned value of the (N+1)th month and a planned value of the (N+2)th month by means of the monthly sales planning process (step S5-3). For example, when a new product is sold, a variation in sales is great. In this case, a sales plan according to circumstance can be formulated by correcting the plan every week. Further, since the planned value of the (N+1)th month and the planned value of the (N+2)th month are calculated while reflecting this weekly plan, a production schedule can be arranged in accordance therewith.

In the embodiment, the past delivery performance is converted into twenty workdays, and the ratio of a 20-day standard is determined. This is further converted into the sales planned value of actual workdays. Therefore, a daily planned value can be efficiently obtained.

The foregoing embodiment may be modified as follows. In the embodiment, the suitability of the bulk-sales-negotiation managing subject is determined in accordance with a basic number that has the possibility of influencing a production schedule. For example, if the number of products ordered in one piece of sales negotiation is 30 or more, this is regarded as a bulk-sales-negotiation managing subject. Instead, the standard of the bulk-sales-negotiation matter may be changed in accordance with the past results. For example, the managing computer 21 may specify a quantity that corresponds to a normal order in the delivery performance, and, with this quantity as a reference value, a determination may be made of whether the sales negotiation is a bulk-sales-negotiation managing subject.

Additionally, the determination standard may be changed in accordance with a production-plan quantity. For example, the managing computer 21 may specify a quantity in a predetermined range of the production-plan quantity, and, with this quantity in the predetermined range as a reference value, a quantity that exceeds this range may be treated as a bulk-sales-negotiation matter. The absolute number that influences a production schedule depends on the product type of a product. Especially if the number of products to be produced is small, an influence will be easily exerted thereon. Even in these circumstances, it is possible to provide a sales plan to arrange a more proper production schedule.

In the embodiment, a main-body sales plan or an option sales plan is corrected based on the decision DB. Herein, the sales plan is corrected by release information about a sales promotion campaign or about a new series. The managing computer 21 may be allowed to calculate a correction value. For example, a keyword of an event where a decision should be executed and data concerning a correction coefficient corresponding to this keyword are registered. After that, event information collected from, for example, a sales company is matched with this keyword. With respect to the information including the keyword, a correction proposal in which a related correction value of the event is multiplied by the delivery performance of the sales company is formed. As a result, it is possible to obtain a number where a decision has been efficiently executed.

In the embodiment, when a seasonal coefficient is calculated, the managing computer 21 calculates a seasonal-index base value (step S3-1). Herein, a moving average value is used. The total of the performance values until the month concerned from eleven months ago is calculated, and the moving average value of the month concerned is obtained by dividing the total value by 12. The seasonal-index base value of the month concerned is then obtained by dividing the delivery performance of the month concerned by the moving average value. Further, the managing computer 21 calculates a monthly seasonal index average value excluding the maximum value and the minimum value (step S3-3). Instead, a “24-month method”, a “12-month method”, or a “simple seasonal index method” may be used as step S3-1. According to the 24-month method, performance values from six months ago to five months later and performance values from five months ago to six months later are added together, and are divided by 24 months so as to obtain an ability value. According to the 12-month method, the total of performance values from six months ago to five months later is divided by 12 months so as to obtain an ability value. According to the simple seasonal index method, an ability value is obtained from the performance value of one year of the term concerned of a month in which the ability value is calculated. A “previous year method” or a “3-year method” may be used as step S3-3. According to the previous year method, seasonal-index base values of 12 months of the previous year are arranged to set a seasonal index. According to the 3-year method, seasonal-index base values of the previous three years are averaged for each month.

In the embodiment, a weekly sales plan is formulated about a predetermined product. Instead, a target product for which a weekly sales plan is arranged may be changed according to circumstances. For example, the managing computer calculates the rate of divergence between a schedule and a performance (a result), and specifies the product type of a product having a large rate of divergence, whereby a weekly sales plan is formulated. As a result, a weekly plan can be dynamically formulated according to circumstances. With respect to a product that can be managed by a monthly plan, the weekly planning process that has a large calculation load is not performed, and hence a system load can be reduced.

According to the embodiments described above, it is possible to arrange a sales plan exactly and efficiently.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A system for supporting creation of a sales plan for products, the system comprising:
a receiving unit configured to receive data on sales negotiations for the products;
a detecting unit configured to detect a specific negotiation, based on a predetermined condition, from among the sales negotiations;
a specific-negotiation storing unit configured to apply an identifier to data of the specific negotiation, and to store the data of the specific negotiation, the data including an amount of scheduled shipments of the products and an amount of completed shipments;
a completed-shipment storing unit configured to store data on an amount of completed shipments of each negotiation;
a regular-shipment calculating unit configured to calculate an amount of completed shipments of regular negotiation that does not correspond to the specific negotiation by subtracting the amount of completed shipments of the specific negotiation from the amount of completed shipments in the completed-shipment storing unit; and
a sales-plan creating unit configured to create a sales plan for the products based on the amount of completed shipments of the regular negotiation and the amount of scheduled shipments of the specific negotiation.

2. The system according to claim 1, wherein the predetermined condition is satisfied when a quantity of the products handled in a sales negotiation exceeds a predetermined quantity.

3. The system according to claim 1, wherein the product include includes a core part and an optional part,
the system further comprising an option-plan creating unit configured to acquire an option attachment rate at which the optional part is sold together with the core part based on the data on the amount of the completed shipments in the completed-shipment storing unit, to acquire an amount of scheduled shipments for the optional part from the amount of scheduled shipments in the specific-negotiation storing unit, and to create an option sales plan based on the amount of completed shipments of the regular negotiation, the option attachment rate, and the amount of scheduled shipments for the optional part.

4. The system according to claim 1, further comprising:
a subdivision-plan creating unit configured to classify the data on the amount of completed shipments in the complete-shipment storing unit into subdivisions, to calculate a ratio of each subdivision in the amount of complete shipments, to create a target-period sales plan for the products of the regular negotiation based on the ratio, the amount of completed shipments in the complete-shipment storing unit, and number of days in a target period for which a sales plan is to be created, and to create a subdivision sales plan by adding the amount of scheduled shipment of the specific negotiation; and
a landing-prospect calculating unit configured to calculate a rate of divergence between the subdivision sales plan and the subdivided data, and to calculate a landing prospect based on the rate of divergence and the subdivision sales plan.

5. The system according to claim 4, further comprising a sales-plan correcting unit configured to replace the amount of completed shipment of the regular negotiation in the complete-shipment storing unit with the landing prospect to create a corrected sales plan for the products of the regular negotiation.

6. A method of supporting creation of a sales plan for products, the method comprising:
receiving data on sales negotiations for the products;
detecting a specific negotiation, based on a predetermined condition, from among the sales negotiations;
adding an identifier to data of the specific negotiation;
storing the data of the specific negotiation, the data including an amount of scheduled shipments of the products and an amount of completed shipments;
storing data on an amount of completed shipments of each negotiation;
calculating an amount of completed shipments of a regular negotiation that does not correspond to the specific negotiation by subtracting the amount of completed shipments of the specific negotiation from the amount of completed shipments of each negotiation; and
creating a sales plan for the products based on the amount of completed shipments of the regular negotiation and the amount of scheduled shipments of the specific negotiation.

7. The method according to claim 6, wherein the predetermined condition is satisfied when a quantity of the products handled in a sales negotiation exceeds a predetermined quantity.

8. The method according to claim 6, wherein the product include includes a core part and an optional part,
the method further comprising:
acquiring an option attachment rate at which the optional part is sold together with the core part based on the data on the amount of the completed shipments of each negotiation;
acquiring an amount of scheduled shipments for the optional part from the amount of scheduled shipments of the specific negotiation; and
creating an option sales plan based on the amount of completed shipments of the regular negotiation, the option attachment rate, and the amount of scheduled shipments for the optional part.

9. The method according to claim 6, further comprising:
classifying the data on the amount of completed shipments of each negotiation into subdivisions;
calculating a ratio of each subdivision in the amount of complete shipments;
creating a target-period sales plan for the products of the regular negotiation based on the ratio, the amount of completed shipments of each negotiation, and number of days in a target period for which a sales plan is to be created;
creating a subdivision sales plan by adding the amount of scheduled shipment of the specific negotiation;
calculating a rate of divergence between the subdivision sales plan and the subdivided data; and
calculating a landing prospect based on the rate of divergence and the subdivision sales plan.

10. The method according to claim 9, further comprising replacing the amount of completed shipment of the regular negotiation of each negotiation with the landing prospect to create a corrected sales plan for the products of the regular negotiation.

11. A computer-readable recording medium that stores a computer program for supporting creation of a sales plan for products, the computer program making a computer execute:
receiving data on sales negotiations for the products;
detecting a specific negotiation, based on a predetermined condition, from among the sales negotiations;
adding an identifier to data of the specific negotiation;
storing the data of the specific negotiation, the data including an amount of scheduled shipments of the products and an amount of completed shipments;
storing data on an amount of completed shipments of each negotiation;
calculating an amount of completed shipments of a regular negotiation that does not correspond to the specific negotiation by subtracting the amount of completed shipments of the specific negotiation from the amount of completed shipments of each negotiation; and
creating a sales plan for the products based on the amount of completed shipments of the regular negotiation and the amount of scheduled shipments of the specific negotiation.

12. The computer-readable recording medium according to claim 11, wherein the predetermined condition is satisfied when a quantity of the products handled in a sales negotiation exceeds a predetermined quantity.

13. The computer-readable recording medium according to claim 11, wherein the product include includes a core part and an optional part,
the computer program further makes the computer execute:
acquiring an option attachment rate at which the optional part is sold together with the core part based on the data on the amount of the completed shipments of each negotiation;
acquiring an amount of scheduled shipments for the optional part from the amount of scheduled shipments of the specific negotiation; and
creating an option sales plan based on the amount of completed shipments of the regular negotiation, the option attachment rate, and the amount of scheduled shipments for the optional part.

14. The computer-readable recording medium according to claim 11, wherein the computer program further makes the computer execute:
classifying the data on the amount of completed shipments of each negotiation into subdivisions;
calculating a ratio of each subdivision in the amount of complete shipments;
creating a target-period sales plan for the products of the regular negotiation based on the ratio, the amount of completed shipments of each negotiation, and number of days in a target period for which a sales plan is to be created;
creating a subdivision sales plan by adding the amount of scheduled shipment of the specific negotiation;
calculating a rate of divergence between the subdivision sales plan and the subdivided data; and
calculating a landing prospect based on the rate of divergence and the subdivision sales plan.

15. The computer-readable recording medium according to claim 14, wherein the computer program further makes the computer execute replacing the amount of completed shipment of the regular negotiation of each negotiation with the landing prospect to create a corrected sales plan for the products of the regular negotiation.
